(19) United States
(12) Patent Application Publication
(10) Pub. No.: US 2017/0095800 A1
(43) Pub. Date: Apr. 6, 2017

(54) Nickel-Doped Copper-Manganese Spinel as Zero-PGM Catalyst for TWC Applications

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(73) Assignee: Clean Diesel Technologies, Inc., Oxnard, CA (US)

(21) Appl. No.: 14/872,609

(22) Filed: Oct. 1, 2015

(51) Int. Cl. B01J 23/755; B01J 23/847; B01J 23/83

(52) U.S. Cl. CPC B01J 23/755; B01J 23/83; B01J 23/8474

(57) ABSTRACT

Variations of ZPGM catalyst material compositions including doped Cu—Mn spinel supported on doped zirconia support oxide are disclosed. The disclosed ZPGM catalyst compositions include a small substitution of Ni within the A-site or B-site cation of a Cu—Mn spinel supported on doped zirconia support oxide, and produced by the incipient wetness (IW) methodology. Bulk powder ZPGM catalyst compositions are subjected to XRD analyses to determine the spinel phase formation and stability. Additionally, bulk powder ZPGM catalyst compositions are subjected to a steady-state isothermal sweep test to determine NO, CO, and THC conversion. The ZPGM catalyst material compositions including Ni-doped Cu—Mn spinel supported on doped zirconia support oxide exhibit improved levels in NO and CO conversions, which can be employed in ZPGM catalysts for a plurality of TWC applications, thereby leading to a more effective utilization of ZPGM catalyst materials with high thermal and chemical stability in TWC products.

### BACKGROUND

Field of the Disclosure

This disclosure relates generally to catalyst materials for three-way catalyst (TWC) applications, and more particularly, to catalyst material compositions for high conversion capacity of NOx, CO, and THC pollutants.

Background Information

Catalysts within catalytic converters have been used to decrease the pollution associated with exhaust from various sources, such as, automobiles, boats, and other engine-equipped machines. Significant pollutants contained within the exhaust gas of gasoline engines include carbon monoxide (CO), unburned hydrocarbons (HC), and nitrogen oxides (NO), among others.

Conventional gasoline exhaust systems employ three-way catalysts (TWC) technology and are referred to as three way catalyst (TWC) systems. TWC systems convert the CO, HC and NO into less harmful pollutants. Typically, TWC systems include a substrate structure upon which promoting oxides are deposited. Bimetallic catalysts, based on platinum group metals (PGM), are then deposited upon the promoting oxides. PGM materials include Pt, Rh, Pd, Ir, or combinations thereof. Some TWC systems have been developed to incorporate new catalytic materials. These new catalytic materials have to be thermally stable under the fluctuating exhaust gas conditions. Additionally, the attainment of the requirements regarding the techniques to monitor the degree of the catalyst's deterioration/deactivation demands highly active and thermally stable catalysts.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost TWC system exhibiting catalytic properties substantially similar to or better than the catalytic properties exhibited by TWC systems employing PGM catalyst materials.

### SUMMARY

The present disclosure describes Zero-PGM (ZPGM) material compositions including partial substitution of Ni within the A-site or B-site cation of Cu—Mn spinel supported on doped zirconia support oxide for TWC applications.

In some embodiments, the bulk powder ZPGM catalyst compositions including doped Cu—Mn spinel at different molar ratios supported on doped zirconia support oxide are produced via incipient wetness (IW) methodology. In other embodiments, the effect of partial substitution of Ni within the A-site or B-site cation of Cu—Mn spinel is analyzed for increased performance of NO, CO, and THC conversion.

In some embodiments, the aforementioned bulk powder ZPGM catalyst compositions are subjected to an XRD analysis to determine the spinel phase formation and stability of spinel structures. In other embodiments, the bulk powder ZPGM catalyst compositions are subjected to an isothermal steady-state sweep test to assess/verify NO, CO, and THC conversions. Activity results are then compared to demonstrate the performance of ZPGM catalyst compositions for TWC applications.

According to the principles of this present disclosure, test results of bulk powder ZPGM catalyst compositions exhibiting significant NO and CO conversion performance can be used in the development of improved ZPGM catalyst materials. The disclosed bulk powder ZPGM catalyst compositions can provide an essential advantage given the economic factors involved when completely or substantially PGM-free materials are used to manufacture ZPGM catalysts for a plurality of TWC applications.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 is a graphical representation illustrating an x-ray diffraction (XRD) phase stability analysis of an exemplary A-site partially doped Cu—Mn spinel, according to an embodiment.

FIG. 2 is a graphical representation illustrating an XRD phase stability analysis of exemplary B-site partially doped Cu—Mn spinets, according to an embodiment.

FIG. 3 is a graphical representation illustrating a comparison of steady-state sweep test results for NO conversion of the A-site partially doped Cu—Mn spinels as well as a reference spinel composition, according to an embodiment.

FIG. 4 is a graphical representation illustrating a comparison of steady-state sweep test results for CO and THC conversion of the A-site partially doped Cu—Mn spinels as well as a reference spinel composition, according to an embodiment.

FIG. 5 is a graphical representation illustrating a comparison of steady-state sweep test results for NO conversion of the B-site partially doped Cu—Mn spinels as well as a reference spinel composition, according to an embodiment.

FIG. 6 is a graphical representation illustrating a comparison of steady-state sweep test results for THC conversion of the B-site partially doped Cu—Mn spinels as well as a reference spinel composition, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Definitions

“Calcination” refers to a thermal treatment process applied to solid materials, in presence of air, to bring about a thermal decomposition, phase transition, or removal of a volatile fraction at temperatures below the melting point of the solid materials.

“Catalyst” refers to one or more materials that may be of use in the conversion of one or more other materials.

“Conversion” refers to the chemical alteration of at least one material into one or more other materials.

“Incipient wetness (IW)” refers to the process of adding solution of catalytic material to a dry support oxide powder until all pore volume of support oxide is filled out with solution and mixture goes slightly near saturation point.

“Lean condition” refers to exhaust gas condition with an R-value less than 1.

“Platinum Group Metal (PGM)” refers to platinum, palladium, ruthenium, iridium, osmium, and rhodium.

“R-value” refers to the value obtained by dividing the reducing potential of the catalyst by the oxidizing potential of the catalyst.

“Rich condition” refers to exhaust gas condition with an R-value greater than 1.

“Spinel” refers to any minerals of the general formulation AB₂O₄ where the A ion and B ion are each selected from mineral oxides, such as, magnesium, iron, zinc, manganese, aluminum, chromium, or copper, among others.

“Support oxide” refers to porous solid oxides, typically mixed metal oxides, which are used to provide a high surface area, which aids in oxygen distribution and exposure of catalysts to reactants such as NO, CO, and hydrocarbons.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“Treating, treated, or treatment” refers to drying, firing, heating, evaporating, calcining, or mixtures thereof.

“X-ray diffraction (XRD) analysis” refers to a rapid analytical technique for identifying crystalline material structures, including atomic arrangement, crystalline size, and imperfections in order to identify unknown crystalline materials (e.g., minerals, inorganic compounds).

“Zero platinum group (ZPGM) catalyst” refers to a catalyst completely or substantially free of PGM.

### DESCRIPTION OF THE DISCLOSURE

The present disclosure describes a Zero-PGM (ZPGM) catalyst composition with enhanced conversion capacity of NOₓ, CO, and THC from exhaust systems of gasoline engines. The ZPGM catalyst composition with enhanced conversion capacity provides improved performance of three-way catalyst (TWC) systems and includes the substitution of Ni at either the A-site or B-site cation of a binary spinel deposited onto suitable support oxide powders. In some embodiments, the use of ZPGM catalyst materials, which are abundant and less expensive than PGMs and rare earth metals, provide for cost effective manufacturing and improved catalytic performance in TWC applications.

### Bulk Powder ZPGM Material Composition and Preparation

In some embodiments, the ZPGM catalyst samples are produced by implementing partial substitution of Ni within the A-site cation of Cu₁Mn₂O₄ spinel employing a general formulation NiₓCu₁₋ₓ, Mn₂O₄, where x is a variable for different molar ratios. In these embodiments, x takes a value from about 0.01 to about 0.5.

In other embodiments, the ZPGM catalyst samples are produced by implementing partial substitution of Ni within the B-site cation of Cu₁Mn₂O₄ spinel employing a general formulation Cu₁Mn₂₋ₓNiₓO₄, where x is a variable for different molar ratios. In these embodiments, x takes a value from about 0.1 to about 1.5.

In some embodiments, the ZPGM catalyst samples are produced by physically mixing the appropriate amount of Cu nitrate, Mn nitrate, and Ni nitrate solutions, according to formulations illustrated in Table 1. In these embodiments, the mixed Cu, Mn, and Ni nitrate solution is drop wise added to the support oxide powder by incipient wetness (IW) methodology. Examples of materials suitable for use as support oxides include MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10%ZrO₂, TiO₂-10%Nb₂O₅, SnO₂—TiO₂, ZrO₂—SnO₂-TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La, amongst others. In an example, the support oxide is implemented as a doped zirconia (_{Zr02-10}%_{Pr6011}) support oxide.

Further to these embodiments, the resulting catalyst material is dried overnight at about 120 ° C., and calcined at a plurality of temperatures. In these embodiments, calcination is preferably performed at about 800° C. for about 5 hours. Further to these embodiments, the calcined material of Ni-doped Cu—Mn spinel is ground into a fine grain bulk powder.

TABLE 1
Ni-doped Cu—Mn spinels supported
on doped zirconia support oxide.

| SAMPLE | DESCRIPTION | FORMULATION |
|---|---|---|
| 1A | Ni in A Site | Ni_{0.02}Cu_{0.98}Mn₂O₄/DOPED ZIRCONIA |
| 1B | Ni in A Site | Ni_{0.2}Cu_{0.8}Mn₂O₄/DOPED ZIRCONIA |
| 2A | Ni in B Site | Cu₁Mn_{1.5}Ni_{0.5}O₄/DOPED ZIRCONIA |
| 2B | Ni in B Site | Cu₁Mn_{0.5}Ni_{1.5}O₄/DOPED ZIRCONIA |
| C | REFERENCE | Cu₁Mn₂O₄/DOPED ZIRCONIA |

Partial Substitution of Ni within the A-site Cation of Cu—Mn Spinel

In some embodiments, bulk powder ZPGM catalyst compositions include Sample 1A and Sample 1B. In these embodiments, Sample 1A and Sample 1B are produced by the substitution of Ni within the A-site cation in a general formulation of a NiₓCu₁₋ₓ, Mn₂O₄spinel structure, where x=0.01 to x=0.5, as illustrated in Table 1 above. In an example, the preparation of Sample 1A includes a partial substitution of Ni within the A-site cation of x=0.02 yielding the formula of Ni_{0.02}Cu_{0.98}Mn₂O₄ spinel structure deposited onto the doped zirconia support oxide. In another example, the preparation of Sample 1B includes a partial substitution of Ni within the A-site cation of x=0.2 yielding the formulation of Ni_{0.2}Cu_{0.8}Mn₂O₄ spinel structure deposited onto the doped zirconia support oxide powder.

Partial Substitution of Ni within the B-site of Cu—Mn Spinel

In some embodiments, bulk powder ZPGM catalyst compositions include Sample 2A and Sample 2B. In these embodiments, Sample 2A and Sample 2B are produced by the substitution of Ni within the B-site cation in a general formulation of Cu₁Mn₂₋ₓNiₓO₄ spinel structure, where x=0.1 to x=1.5, as illustrated in Table 1 above. In an example, the preparation of sample 2A includes a partial substitution of Ni within the B-site cation of x=0.5 yielding the formula of Cu₁Mn_{1.5}Ni_{0.5}O₄spinel structure deposited onto the doped zirconia support oxide powder. In another example, the preparation of sample 2B includes a partial substitution of Ni within the B-site cation of x=1.5 yielding the formulation of Cu₁Mn_{0.5}Ni_{1.5}O₄ spinel structure deposited onto the doped zirconia support oxide powder.

X-ray Diffraction Analysis of Partial Substitution of Ni within the A and B Sites of Cu—Mn Spinel

In some embodiments, x-ray diffraction (XRD) tests are used to analyze/measure the phase formation as well as the stability of spinel structures after substitution of Ni within the A-site cation of a Ni_{0.2}Cu_{0.8}Mn₂O₄ spinel structure (Sample 1B), substitution of Ni within the B-site cation of a Cu₁Mn_{1.5}Ni_{0.5}O₄ spinel structure (Sample 2A), as well as substitution of Ni within the B-site cation of a Cu₁Mn_{0.5}Ni _{1.5}O₄ spinel structure (Sample 2B). In these embodiments, the XRD data is analyzed to determine if the structures of the Ni_{0.2}Cu_{0.8}Mn₂O₄ spinel, the Cu₁Mm _{1.5} Ni_{0.5}O₄ spinel, and the Cu₁Mn_{0.5}Ni _{1.5}O₄ spinel remain stable. Further to these embodiments, the XRD data is also analyzed to determine the phase structure of the spinel that are calcined at a temperature of about 800° C. for about 5 hours.

In some embodiments, XRD patterns are measured using a powder diffractometer employing Cu Ka radiation in the 2-theta range band of about 15° -100° with a step size of about 0.02° and having a dwell time of about 1 second increments. In these embodiments, the tube voltage and the current are set to about 40 kV and about 30 mA, respectively. The resulting diffraction patterns are analyzed using the International Center for Diffraction Data (ICDD) database to identify phase formation. Examples of powder diffractometer include the MiniFlex™ powder diffractometer available from Rigaku® of Woodlands, Tex., USA.

Isothermal Steady State Sweep Test Procedure

In some embodiments, an isothermal steady-state sweep test is performed on catalyst samples at an inlet temperature of about 450° C. and employing a gas stream having 11-point R-values from about 2.00 (rich condition) to about 0.80 (lean condition) to measure the NO, CO, and HC conversions. In an example, the isothermal steady-state sweep test is performed employing a gas stream having R-values from about 1.60 (rich condition) to about 0.90 (lean condition) to measure the NO, CO, and HC conversions.

In these embodiments, the space velocity (SV) in the isothermal steady-state sweep test is set at about 90,000 h⁻¹. Further to these embodiments, the gas feed employed for the test is a standard TWC gas composition, with variable O₂ concentration, in order to adjust R-value from rich condition to lean condition during testing. In these embodiments, the standard TWC gas composition includes about 8,000 ppm diluted in inert CO, about 400 ppm of C₃H₆, about 100 ppm of C₃H₈, about 1,000 ppm of NO_{R}, about 2,000 ppm of H₂, about 10% of CO₂, and about 10% of H₂O. The quantity of O₂ within the gas mix is varied to regulate the Air/Fuel (A/F) ratio within the range of R-values to adjust the gas stream.

In other embodiments, a reference catalyst sample composition is employed for determination of NO, CO, and THC conversion performance of the ZPGM catalyst material compositions employing the aforementioned isothermal steady state sweep test. In these embodiments, the ZPGM catalyst material compositions include Ni-doping within the A and B site cations of Cu—Mn spinel structures.

XRD Diffraction Analysis of Partial Substitution of Ni within A-site Cation of Cu—Mn Spinel

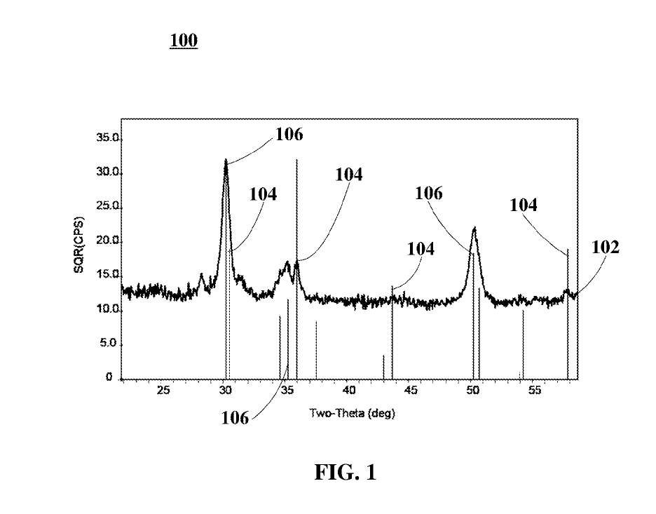

FIG. 1 is a graphical representation illustrating an x-ray diffraction (XRD) phase stability analysis of an exemplary A-site partially doped Cu—Mn spinel (Sample 1B, above), at about 800° C., according to an embodiment. In FIG. 1, XRD analysis 100 includes XRD spectrum 102, solid lines 104, and solid lines 106.

In some embodiments, XRD spectrum 102 illustrates bulk powder Ni_{0.2}Cu_{0.8}Mn₂O₄ spinel supported on doped zirconia support oxide (Sample 1B) and calcined at a temperature of about 800 ° C. In these embodiments and after calcination, a Ni_{0.2}Cu_{0.8}Mn₂O₄ spinel phase is produced as illustrated by solid lines 104. Further to these embodiments, a tetragonal zirconia (ZrO₂) phase from the support oxide is detected as illustrated by solid lines 106.

XRD Diffraction Analysis of Partial Substitution of Ni within B-site Cation of Cu—Mn Spinel

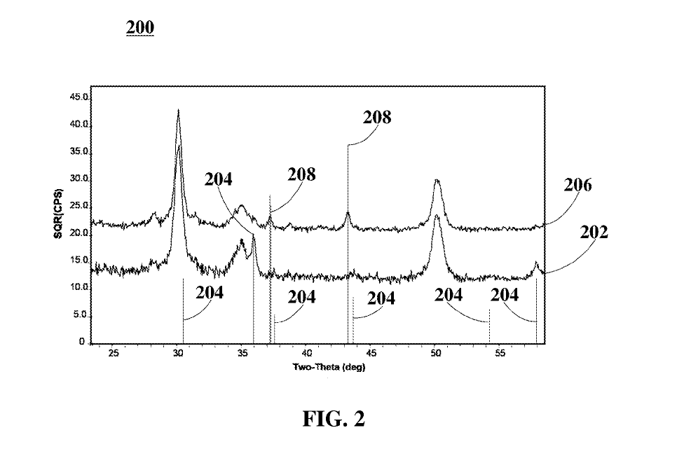

FIG. 2 is a graphical representation illustrating an XRD phase stability analysis of exemplary B-site partially doped Cu—Mn spinels (Samples 2A and 2B, above), at about 800° C., according to an embodiment. In FIG. 2, XRD analysis 200 includes XRD spectrum 202, solid lines 204, XRD spectrum 206, and solid lines 208.

In some embodiments, XRD spectrum 202 illustrates bulk powder Cu₁Mn_{1.5}Ni_{0.5}O₄ spinel supported on doped zirconia support oxide (Sample 2A) and calcined at a temperature of about 800° C., and XRD spectrum 206 illustrates bulk powder Cu₁Mn_{0.5}Ni _{1.5}O₄ spinel supported on doped zirconia support oxide (Sample 2B) and calcined at a temperature of about 800° C.

In these embodiments and after calcination, a Cu₁Mn_{1.5}Ni_{0.5}O₄ (Sample 2A) phase is produced as a result of said calcination, as illustrated by solid lines 204. Further to these embodiments, the calcination of the Cu₁Mn_{1.5}Ni_{0.5}O₄ does not result in the production of additional binary compounds of Cu, Mn, and Ni, nor does the calcination result in the production of separate Ni, Cu, or Mn oxides.

In other embodiments and after calcination, a Cu₁Mn_{0.5}Ni_{1.5}O₄ (Sample 2B) phase is produced including a small phase intensity as a result of said calcination (not shown). In these embodiments, a significant separate phase of NiO is additionally produced, as illustrated by solid lines 208. Further to these embodiments, when Ni doping exceeds an accepted capacity of the B-site cation (e.g., Niₓ, where x≧1.5) within the Cu—Mn spinel, the Ni forms a separate oxide phase outside of the Cu—Mn spinel. In these embodiments, the un-assigned diffraction peaks are the result of ZrO₂, arranged in a tetragonal structure, reacting to the calcination.

Effect of Partial Substitution of Ni within the A-site Cation of Cu—Mn Spinel on NO Conversion

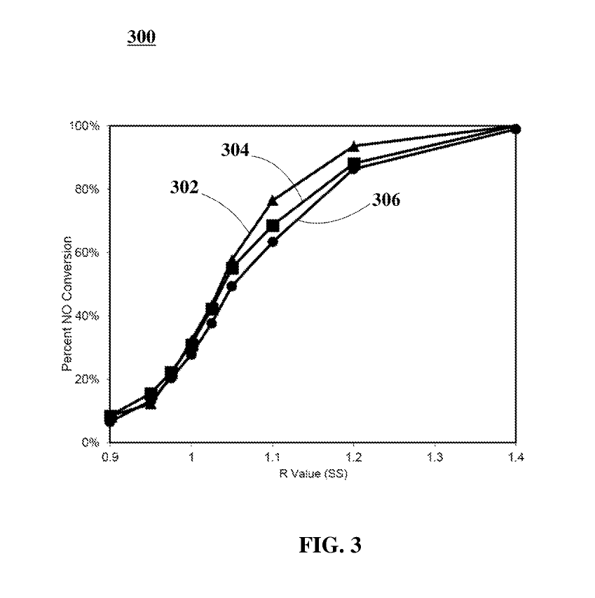

FIG. 3 is a graphical representation illustrating a comparison of steady-state sweep test results for NO conversion of the A-site partially doped Cu—Mn spinels (Samples 1A and 1B) as well as a reference spinel composition, according to an embodiment. In FIG. 3, catalyst performance comparison 300 includes conversion curve 302, conversion curve 304, and conversion curve 306.

In some embodiments, conversion curve 302 illustrates NO conversion associated with bulk powder Ni_{0.02}Cu_{0.98}Mn₂O₄ spinel supported on doped zirconia support oxide (Sample 1A). In these embodiments, conversion curve 304 illustrates NO conversion associated with bulk powder Ni_{0.2}Cu_{0.8}Mn₂O₄ spinel supported on doped zirconia support oxide (Sample 1B). Further to these embodiments, conversion curve 306 illustrates NO conversion associated with bulk powder Cu₁Mn₂O4 spinel supported on doped zirconia support oxide (reference sample).

In some embodiments, the catalytic activity of the aforementioned bulk powder samples is analyzed at R-value of 1.10. In these embodiments and at this R-value, conversion curve 302 exhibits the highest level of NO conversion at about 76.5%, while conversion curve 304 exhibits NO conversion of about 68.6%, and conversion curve 306 exhibits NO conversion at about 63.4%. Further to these embodiments, a small substitution of Cu by Ni within the A-site cation (Sample 1A or 1B) of the Cu—Mn spinel slightly increases NO conversion.

Effect of Partial Substitution of Ni within the A-site Cation of Cu—Mn Spinel on CO and THC Conversion

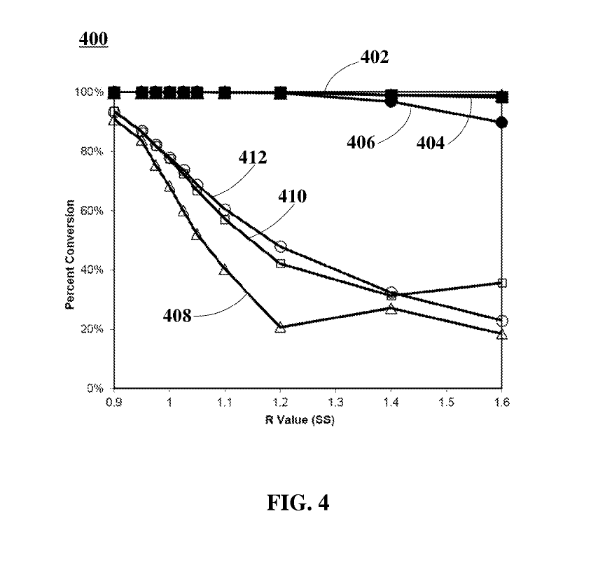

FIG. 4 is a graphical representation illustrating a comparison of steady-state sweep test results for CO and THC conversion of the A-site partially doped Cu—Mn spinets (Samples 1A and 1B) as well as a reference spinel composition, according to an embodiment. In FIG. 4, catalyst performance comparison 400 includes conversion curve 402, conversion curve 404, conversion curve 406, conversion curve 408, conversion curve 410, and conversion curve 412.

In some embodiments, conversion curve 402 illustrates CO conversion associated with bulk powder Ni_{0.02}Cu_{0.98}Mn₂O₄ spinel supported on doped zirconia support oxide (Sample 1A), conversion curve 404 illustrates CO conversion associated with bulk powder Ni_{0.2}Cu_{0.8}Mn₂O₄ spinel supported on doped zirconia support oxide (Sample 1B), and conversion curve 406 illustrates CO conversion associated with bulk powder Cu₁Mn₂O₄ spinel supported on doped zirconia support oxide (reference sample). In these embodiments, conversion curve 408 illustrates THC conversion associated with bulk powder Ni_{0.02}Cu_{0.98}Mn₂O₄ spinel supported on doped zirconia support oxide (Sample 1A), conversion curve 410 illustrates THC conversion associated with bulk powder Ni_{0.2}Cu_{0.8}Mn₂O₄ spinel supported on doped zirconia support oxide (Sample 1B), and conversion curve 412 illustrates THC conversion associated with bulk powder Cu₁Mn₂O₄ spinel supported on doped zirconia support oxide (reference sample).

In some embodiments, the catalytic activity of the aforementioned bulk powder samples is analyzed at R-value of 0.90. In these embodiments and at this R-value, conversion curve 402 and conversion curve 404 exhibit the highest level of CO conversions at about 100%, maintaining catalytic activity along the range of R-values. Further to these embodiments, conversion curve 406 exhibits CO conversion of about 100%, and decreasing continually along the range of R-values to about 89.8% at R-value 1.60. In these embodiments, a small substitution of Ni within the A-site cation of the Cu—Mn spinel (Sample 1A or 1B) increases CO conversion, while maintaining the stability of the catalytic activity.

In these embodiments and at R-value of 0.90, conversion curve 410 and conversion 412 exhibit the highest level of THC conversion at about 93.3%. Further to these embodiments, conversion curve 410 (Sample 1B) and conversion curve 412 (reference sample) exhibit a rapid reduction of THC conversion to about 32.4% at R-value 1.40. In these embodiments, conversion curve 408 (Sample 1A) exhibits a THC conversion of about 90.7%, decreasing at a more rapid rate to about 20.7% at R-value 1.20. Further to these embodiments, a small substitution of Ni within the A-site cation (Sample 1A or 1B) of the Cu—Mn spinel decreases THC conversion.

Effect of Partial Substitution of Ni within the B-site Cation of Cu—Mn Spinel on NO Conversion

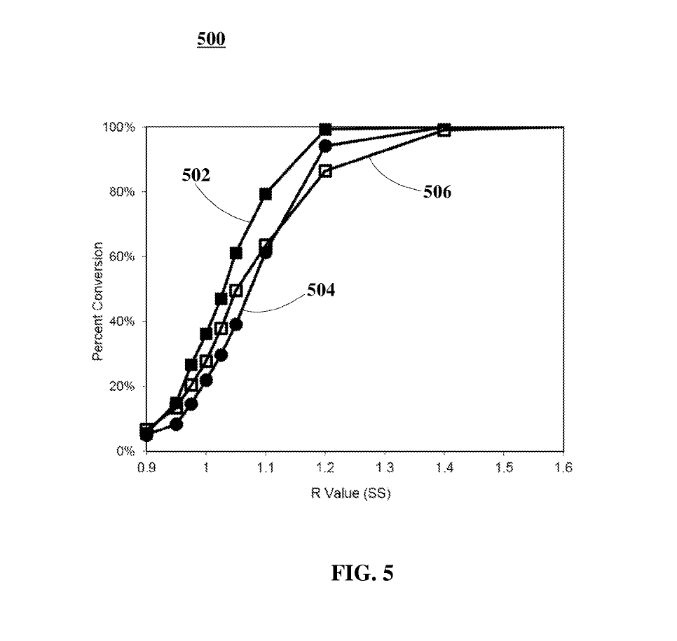

FIG. 5 is a graphical representation illustrating a comparison of steady-state sweep test results for NO conversion of the B-site partially doped Cu—Mn spinets (Samples 2A and 2B), as well as a reference spinel composition, according to an embodiment. In FIG. 5, catalyst performance comparison 500 includes conversion curve 502, conversion curve 504, and conversion curve 506.

In some embodiments, conversion curve 502 illustrates NO conversion associated with bulk powder Cu₁Mn_{1.5}Ni_{0.5}O₄ spinel supported on doped zirconia support oxide (Sample 2A). In these embodiments, conversion curve 504 illustrates NO conversion associated with bulk powder Cu₁Mn_{0.5}Ni_{1.5}O₄ spinel supported on doped zirconia support oxide (Sample 2B). Further to these embodiments, conversion curve 506 illustrates NO conversion associated with bulk powder Cu₁Mn₂O₄ spinel, supported on doped zirconia support oxide (reference sample).

In some embodiments, the catalytic activity of the aforementioned bulk powder samples is analyzed at R-values of 1.10 and 1.20. In these embodiments and at an R-value of 1.10, conversion curve 502 exhibits a higher level of NO conversion at about 79.4% when compared to conversion curves 504 and 506 exhibiting NO conversion at about 61.4% and about 63.4%, respectively. Further to these embodiments, conversion curve 502 exhibits a rapid increase of NO conversion to 100% at an R-value of 1.20 and NO conversion remains constant along the range of R-values during rich conditions. In these embodiments and at R-value of 1.20, conversion curves 504 and 506 exhibit an increase of NO conversion at about 86.3% and at about 94.1%, respectively.

In some embodiments, conversion curve 502 (Sample 2A) including a small substitution of Ni within the B-site cation of the Cu—Mn spinel exhibits the highest level of NO conversion when compared to conversion curve 504 (Sample 2B) and conversion curve 506 (reference sample). In these embodiments, the lower NO conversion exhibited by conversion curve 504 (Sample 2B) is related to the presence of NiO outside the spinel phase, as illustrated by the XRD analysis in FIG. 2.

Effect of Partial Substitution of Ni within the B-site Cation of Cu—Mn Spinel on THC Conversion

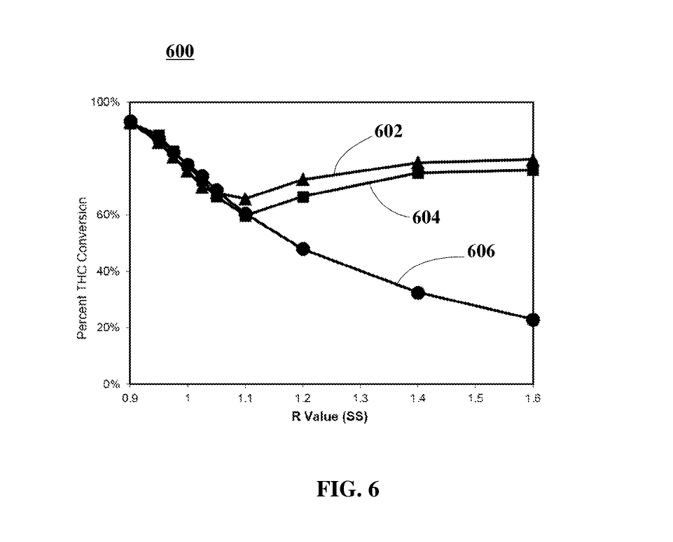

FIG. 6 is a graphical representation illustrating a comparison of steady-state sweep test results for THC conversion of the B-site partially doped Cu—Mn spinets (Samples 2A and 2B), as well as a reference spinel composition, according to an embodiment. In FIG. 6 catalyst performance comparison 600 includes conversion curve 602, conversion curve 604 and conversion curve 606.

In some embodiments, conversion curve 602 illustrates THC conversion associated with bulk powder Cu₁Mn_{1.5}Ni_{0.5}O₄ spinel supported on doped zirconia support oxide (Sample 2A). In these embodiments, conversion curve 604 illustrates THC conversion associated with bulk powder Cu₁Mn_{0.5}Ni_{1.5}O₄ spinel supported on doped zirconia support oxide (Sample 2B). Further to these embodiments, conversion curve 606 illustrates THC conversion associated with bulk powder Cu₁Mn₂O₄ spinel supported on doped zirconia support oxide (reference sample).

In these embodiments, the catalytic activity of the aforementioned bulk powder samples is analyzed at R-values of 0.9 and 1.10. Further to these embodiments and at an R-value of 0.9, conversion curves 602, 604, and 606 exhibit a substantially similar levels of THC conversion at about 93.3%. In these embodiments and at an R-value of 1.10, conversion curves 602 and 604 exhibit THC conversion of about 65.8% and 60.5%, respectively, while conversion curve 606 exhibits THC conversion of about 60.5%. Further to these embodiments and at an R-value of 1.10, conversion curves 602 and 604 exhibit a continuous parallel increase of THC conversion, while conversion curve 606 maintains a continuous decrease of THC conversion. In these embodiments, a small substitution of Ni within the B-site cation (Sample 2A or 2B) of the Cu—Mn spinel substantially increases THC conversion.

According to the principles of this present disclosure, bulk powder ZPGM material compositions including A-site partially doped Cu—Mn spinels (Samples 1A and 1B) exhibit improved levels of NO conversion, while THC conversion is reduced. Additionally, bulk powder ZPGM material compositions including B-site partially doped Cu—Mn spinels (Samples 2A and 2B) exhibit improved levels of NO and THC conversion. Further, bulk powder ZPGM material composition including Cu₁Mn_{1.5}Ni_{0.5}O₄, supported on doped zirconia support oxide (Sample 2A) exhibits improved levels of NO conversion. As such, the aforementioned bulk powder ZPGM material compositions can be used in a large number of TWC catalyst applications with similar or improved performance as compared to existing catalyst materials including PGM and/or rare metals.

While various aspects and embodiments have been disclosed, other aspects, and embodiments may be contemplated. The various aspects and embodiments disclosed here are for purposes of illustration and are not intended to be limiting, with the true scope and spirit being indicated by the following claims.

What is claimed is:

1. A catalyst composition comprising a spinel of formula Cu₁₋ₓNiₓMn₂O₄ wherein x is about 0.01 to about 0.5.

2. The catalyst composition of claim 1, wherein x is about 0.01 to about 0.2.

3. The catalyst composition of claim 2, wherein x is about 0.02.

4. The catalyst composition of claim 1, further comprising at least one support oxide, wherein the spinel of formula Cu₁₋ₓNiₓMn₂O₄ is deposited on the at least one support oxide.

5. The catalyst composition of claim 4, wherein the at least one support oxide is selected from the group consisting of MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂-Y₂O₃-SiO₂, Al₂O₃—CeO₂, Al₂O₃—SrO, TiO₂—ZrO₂, TiO₂—Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La.

6. The catalyst composition of claim 4, wherein the at least one support oxide includes a doped zirconia support oxide.

7. The catalyst composition of claim 6, wherein the doped zirconia support oxide is ZrO₂—Pr₆O₁₁ support oxide.

8. The catalyst composition of claim 7, the ZrO₂—Pr₆O₁₁ support oxide is ZrO₂-10%Pr₆O₁₁ support oxide.

9. The catalyst composition of claim 5, wherein the at least one support oxide includes at least one selected from the group consisting of TiO₂-10%ZrO₂ and TiO₂-10%Nb₂O₅.

10. The catalyst composition of claim 2, further comprising at least one support oxide, wherein the spinel of formula Cu₁₋ₓ NiₓMn₂O₄ is deposited on the at least one support oxide, and wherein the at least one support oxide includes ZrO₂—Pr₆O₁₁ support oxide.

11. A catalyst component comprising a spinel of formula Cu₁Mn₂₋ₓNiₓO₄ wherein x is about 0.1 to about 1.5.

12. The catalyst composition of claim 11, wherein x is about 0.1 to about 0.5.

13. The catalyst composition of claim 12, wherein x is about 0.5.

14. The catalyst composition of claim 11, further comprising at least one support oxide, wherein the spinel of formula CuMn₂₋ₓNiₓO₄ is deposited on the at least one support oxide.

15. The catalyst composition of claim 14, wherein the at least one support oxide is selected from the group consisting of MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂—ZrO₂, TiO₂—Nb₂O₅, SnO₂—TiO₂, ZrO₂—SnO₂—TiO₂, BaZrO₃, BaTiO₃, BaCeO₃, ZrO₂—P₆O₁₁, ZrO₂—Y₂O₃, ZrO₂—Nb₂O₅, Al—Zr—Nb, and Al—Zr—La.

16. The catalyst composition of claim 14, wherein the at least one support oxide includes a doped zirconia support oxide.

17. The catalyst composition of claim 16, wherein the doped zirconia support oxide is ZrO₂—Pr₆O₁₁ support oxide.

18. The catalyst composition of claim 17, the ZrO₂—Pr₆O₁₁ support oxide is ZrO₂-10%Pr₆O₁₁ support oxide.

19. The catalyst composition of claim 15, wherein the at least one support oxide includes at least one selected from the group consisting of TiO₂-10%ZrO₂ and TiO₂-10%Nb₂O₅.

20. The catalyst composition of claim 12, further comprising at least one support oxide, wherein the spinel of formula Cu ₁Mn₂₋ₓNiₓO₄ is deposited on the at least one support oxide, and wherein the at least one support oxide includes ZrO₂—Pr₆O₁₁ support oxide.
